(19) United States
(12) Patent Application Publication
(10) Pub. No.: US 2004/0177335 A1
(43) Pub. Date: Sep. 9, 2004

(54) Enterprise services application program development model

(75) Inventors: Michael Beisiegel, Poughkeepsie, NY (US); Jean-Sebastien Delfino, Toronto (CA); Piotr Przybylski, Brooklin (CA)

Correspondence Address: IBM Corporation T81/503, Intellectual Property Law, PO Box 12195, Res. Tri. Park, NC, 27709, US

(73) Assignee: International Business Machines Corporation, Armonk, NY

(21) Appl. No.: 10/378,972

(22) Filed: Mar. 4, 2003

(51) Int. Cl. G06F 9/44; G06F 17/60

(52) U.S. Cl. 717/102; 705/1

(57) ABSTRACT

A development model for architecting enterprise systems presents a service-oriented approach which leverages open standards to represent virtually all software assets as services including legacy applications, packaged applications, J2EE components or web services. This approach provides developers with a standard way of representing and interacting with parts of a business application without having to spend time working with unique interfaces and low-level APIs. Furthermore, individual business application components become building blocks that can be reused in developing other applications. Using the service-oriented approach to integration in accordance with the present invention reduces the complexity, cost, and risk of integration by providing a single, simple architectural framework based on Web Services in which to build, deploy, and manage application functionality. In one aspect, a services toolkit for an integrated development environment is introduced to facilitate development in accordance with the model.

### FIELD OF THE INVENTION

The present invention relates to computer application development and operation and, more particularly, to enterprise services applications and the development of such applications using an integrated development environment.

### BACKGROUND OF THE INVENTION

Many enterprises today encounter a growing information technology (IT) predicament for their electronic commerce (e-commerce, whereby transactions for a variety of goods and services are conducted electronically) and electronic business (e-business, whereby business processes—e.g., shipping, procurement, staffing, etc.—are transformed so as to be conducted electronically) needs. The evolution of their IT systems has left them with an enterprise-computing infrastructure that is often heterogeneous, widely distributed, and increasingly complex. In the face of pressure to cut costs, build customer loyalties, and gain a competitive advantage, new IT applications are often created to achieve these goals.

Instead of building each new application from the top down, reinventing the wheel, companies need a way to reuse their existing software assets and to leverage the power of web services in the development of new applications. The new applications should themselves provide reusable assets providing leverage to further the goals of cost cutting and competitive advantage in the future. Existing assets may include those that are web based and those which are not, such as legacy back end systems (sometimes referred to as Enterprise Information Systems—EISs, which systems may stand alone and are not designed for web services) to access and store information related to an e-business or e-commerce transaction. For example, a large scale enterprise e-business application may be desired to provide for web-based purchasing of goods or services. Rather than build such an enterprise service-from scratch, such a service may be constructed from numerous existing and new service components to ensure that a good or service purchased is delivered on time to the customer making the purchase.

As a result of the complexity and cost involved with architecting enterprise applications, much research and development has been undertaking to produce an appropriate development model.

One commonly used approached to developing multi tier enterprise applications is to develop in accordance with the Java™ 2 Platform, Enterprise Edition (J2EE) standard of Sun Microsystems, Inc. created in collaboration with others. (Java and all Java-based trademarks are trademarks or registered trademarks of Sun Microsystems, Inc.) J2EE is intended to simplify enterprise applications and their development by basing the applications on standardized, modular components. J2EE further provides a complete set of services to those components, and handles automatically many details of application behavior to avoid complex programming. J2EE extends many features of the Java 2 Platform, Standard Edition for Java based applications and adds full support for Enterprise Java Beans components, Java Servlets API, Java Server Pages and Extensible Markup language (XML) technology. J2EE was developed with a view to facilitating quicker application development and deployment and to producing applications that are portable and scalable for longevity.

Multi tier applications that require the integration of a variety of resources including legacy data and code as well as programmer skill-sets are difficult to design. It is reported that integrating these resources can take up to 50% of application development time. The J2EE standard wraps and embraces existing resources required by multi tier applications with a unified, component-based application model and enables co-operating components, tools, systems, and applications for solving the strategic requirements of an enterprise.

However, J2EE component architecture is not without its limitations and disadvantages. For example, J2EE does not provide to developers a standard way of representing and interacting with software assets without having to spend time working with unique interfaces and low-level APIs. As such, components created are often unique to the interfaces and low-level APIs and cannot be used conveniently as building blocks to be reused in developing other applications. J2EE component architecture is Java language based and requires that non-Java applications be wrapped in J2EE components via J2EE Connector Architecture.

J2EE and its Connector Architecture do not inherently provide a model or standard for abstractly defining the functionality of an enterprise application or a consistent way of interacting with aspects of the enterprise application such as connectors, web services, messaging applications and EJB components.

In furtherance of goals related to interoperability, code re-use and component architecture for defining and offering e-commerce and e-business applications via the protocols of the Internet, a web services model was developed. The functionality of a business application component offered via the Internet or web is described as an abstract service such as in an XML-based document, in accordance with a standard. The description can then be shared with other developers and used to construct clients of the offered service. Access to the service is provided by web based protocols such as Simple Object Access Protocol (SOAP) over Hyper Text Transfer Protocol (HTTP). Web Services Description Language is one such XML-based language for abstractly describing web services. However,.this model is directed to web services and not to enterprise applications generally, lacking an inherent capacity to deal with (i.e. adequately describe) other protocols or bindings, component implementations, backend systems and their specific data requirements. Moreover, as the web protocols are relatively inefficient, the model is not embraced universally.

As such, a development model for architecting enterprise applications which addresses some or all of these shortcomings is desired.

### SUMMARY OF THE INVENTION

The present invention is directed to a service-oriented development model for enterprise applications and an integrated development environment for architecting such applications.

In one aspect of the present invention, there is provided a method for architecting an enterprise application. The method comprises creating one or more services that define said enterprise application, each service created in accordance with a service definition modeling one of a plurality service providers having one of a plurality of types, the service definition conforming to a standard common for differing service provider types. The method further comprises deploying the one or more services where each service is deployed in accordance with an access definition sufficient to access the service. In accordance with this method aspect, the differing service provider types comprise two or more types selected from: access protocols; software assets; resource adapted EIS services; a flow composition defining a service from one or more other services; and a transformer mapping one or more input messages of a particular service to an output message of the particular service.

The service definition comprises a service interface definition and a service implementation definition and, in accordance with a feature of this method, the step of creating comprises, for each service, generating a service interface definition modeling the interface of the service provider; and generating a service implementation definition describing an implementation of the service interface and the location of the implementation. The service interface definition and service implementation definition preferably comprise separate documents which documents may be XML-based and conform to the WSDL standard.

The step of deploying comprises adapting the deployed service for operation on an application server. The method may also comprise a step of defining a service proxy for accessing the deployed service and the service proxy may be defined from a portion of the service definition describing an interface to the service and the access definition for accessing the deployed service.

In accordance with another aspect of the invention there is a services toolkit for architecting an enterprise service. The services toolkit comprises a service creation component for creating one or more services that define said enterprise application, each service created in accordance with a service definition modeling one of a plurality service providers having one of a plurality of service provider types, the service definition conforming to a standard common for differing service provider types. The differing service provider types comprise two or more types selected from access protocols; software assets; resource adapted EIS services; flow compositions, each flow defining a service from one or more other services; and transformers each transformer mapping one or more input messages of a particular service to an output message of the particular service. IN accordance with this services toolkit, the toolkit further comprises a service deployment component for deploying the one or more services in accordance with a respective access definition sufficient to access a respective service and the services toolkit is adapted to communicate with an integrated development environment to assist with architecting the enterprise application.

The services toolkit may including one or more tools to assist with the creation of the service definition for each service provider type. Particularly, the services toolkit may comprise one or more of: a service provider browser to facilitate a selection of a service provider type to create the service definition; a service definition editor for generating a service interface definition modeling the interface of the service provider; and at least one service implementation editor for generating a service implementation definition describing an implementation of a service interface of the service and the location of the implementation. A particular service implementation editor may comprises a flow editor for generating flow compositions graphically or a transformer editor for defining data transformations in accordance with a standard therefor.

Service definitions may comprises a service interface definition and a service implementation definition defined by separate documents, which may be XML documents and which XML documents may conform to the WSDL standard.

One feature of the services toolkit includes a tool for at least one of importing and exporting the service definition to facilitate creating at least one of a service and a client application to use the service. Further, the service deployment component comprises a tool for adapting the deployed service for operation on an application server and may include a service proxy wizard for creating a service proxy to access the deployed service. A service skeleton wizard may be included to at least partially generate a service provider from a service definition.

The services toolkit may be adapted for architecting enterprise application for operation in a J2EE environment. The access protocols may be selected from protocols operable to invoke Java based components; the software assets may be selected from Java based software components; and the resource adapters may be selected from resource adaptors operable in accordance with Java based connector standards.

In accordance with a further aspect, the invention provides a computer program product embodied in a computer readable medium for providing instructions and data to a computer system executing an integrated development environment (IDE) for architecting an enterprise service application. The instructions and data define a services toolkit that, when operated on said computer system, adapts the IDE to (a) create one or more services that define said enterprise application, each service created in accordance with a service definition modeling one of a plurality service providers having one of a plurality of service provider types, the service definition conforming to a standard common for differing service provider types; and (b) deploy the one or more services, each deployed in accordance with an access definition sufficient to access the service. The differing service provider types comprise at least two types selected from access protocols; software assets; resource adapted EIS services; flow compositions, each flow defining a service from one or more other services; and transformers each transformer mapping one or more input messages of a particular service to an output message of the particular service.

In accordance with yet a further aspect, there is provided An integrated development environment (IDE) for architecting an enterprise service comprising: first means for describing a service interface to a service; second means for describing a service implementation to the service, said service implementation binding the service interface to one of a plurality service providers having one of a plurality of service provider types, the second means conforming to a standard common for differing service provider types; third means for generating a service from said first and second means; fourth means for describing a protocol sufficient to access the service; and fifth means for deploying the service in accordance with the fourth means. In accordance with this aspect, the differing service provider types comprise two or more types selected from access protocols; software assets; resource adapted EIS services; flow compositions, each flow defining a service from one or more other services; and transformers each transformer mapping one or more input messages of a particular service to an output message of the particular service.

Advantageously a service-oriented architecture leverages open standards to represent virtually all software assets as services including legacy applications, packaged applications, J2EE components or Web services. This approach provides developers with a standard way of representing and interacting with software assets without having to spend time working with unique interfaces and low-level APIs. Furthermore, individual software assets become building blocks that can be reused in developing other applications.

Using the service-oriented approach to integration in accordance with the present invention reduces the complexity, cost, and risk of integration by providing a single, simple architectural framework based on web services in which to build, deploy, and manage application functionality.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 schematically illustrates a computer system embodying aspects of the invention;

FIG. 2 schematically illustrates, in greater detail, a portion of the computer system of FIG. 1;

FIG. 3 illustrates, in functional block form, a portion of the memory illustrated in FIG. 2;

FIG. 4 illustrates in schematic form a service in accordance with a programming model of this invention;

FIG. 5 illustrates in schematic form a logical service bus for integrating services in an enterprise services environment according to the present invention;

FIG. 6 illustrates the architecture of a WSDL document;

FIGS. 7a, 7b, 7c and 7d illustrate, in greater detail and in functional block form, a portion of FIG. 3;

FIG. 8 illustrates in greater detail and in functional block form, a portion of FIG. 3;

FIG. 9 illustrates, in greater detail and in functional block form, a portion of FIG. 3; and

FIG. 10 is a flow chart of operations performed during the development of an enterprise services application.

### DETAILED DESCRIPTION

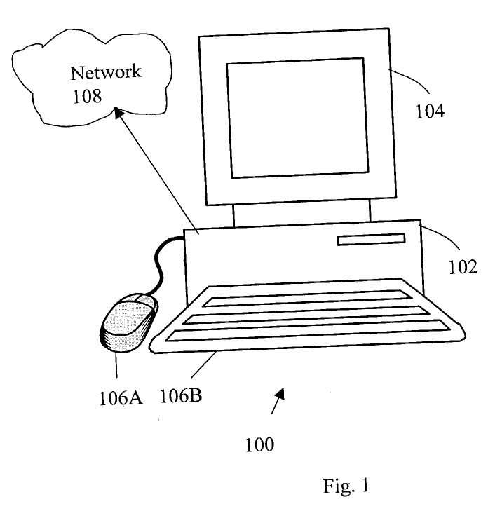

An embodiment of the invention, computer system 100, is illustrated in FIG. 1. Computer system 100, illustrated for exemplary purposes as a networked computing device, is in communication with other networked computing devices (not shown) via network 110. As will be appreciated by those of ordinary skill in the art, network 110 may be embodied using conventional networking technologies and may include one or more of the following: local area networks, wide area networks, intranets, public Internet and the like.

Throughout the description herein, an embodiment of the invention is illustrated with aspects of the invention embodied solely on computer system 100. As will be appreciated by those of ordinary skill in the art, aspects of the invention may be distributed amongst one or more networked computing devices which interact with computer system 100 via one or more data networks such as, for example, network 110. However, for ease of understanding, aspects of the invention have been embodied in a single computing device—computer system 100.

Computer system 100 includes processing system 102 which communicates with various input devices 104, output devices 106 and network 110. Input devices 104, two of which are shown, may include, for example, a keyboard, a mouse, a scanner, an imaging system (e.g., a camera, etc.) or the like. Similarly, output devices 106 (only one of which is illustrated) may include displays, information display unit printers and the like. Additionally, combination input/output (I/O) devices may also be in communication with processing system 102. Examples of conventional I/O devices include removable and fixed recordable media (e.g., floppy disk drives, tape drives, CD-ROM drives, DVD-RW drives, etc.), touch screen displays and the like.

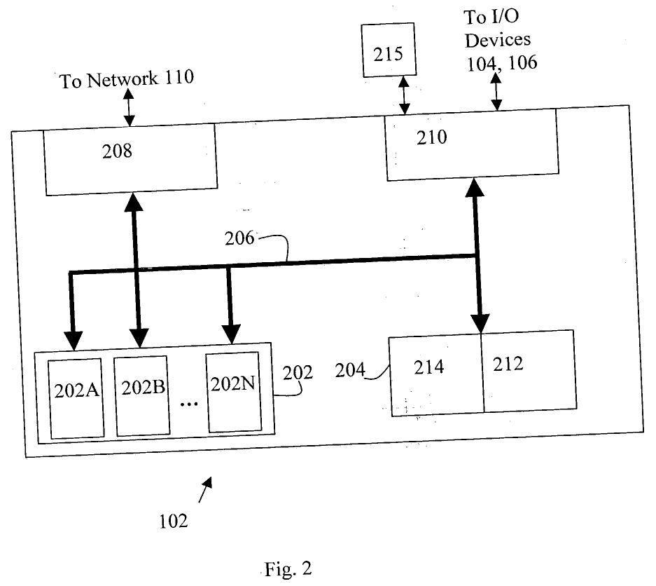

Exemplary processing system 102 is illustrated in greater detail in FIG. 2. As illustrated, processing system 102 includes several components—central processing unit (CPU) 202, memory 204, network interface (I/F) 208 and I/O I/F 210. Each component is in communication with the other components via a suitable communications bus 206 as required.

CPU 202 is a processing unit, such as an Intel Pentium™, IBM PowerPC™, Sun Microsystems UltraSparc™ processor or the like, suitable for the operations described herein. As will be appreciated by those of ordinary skill in the art, other embodiments of processing system 102 could use alternative CPUs and may include embodiments in which one or more CPUs are employed (for example 202A, 202B, . . . 202N). CPU 202 may include various support circuits to enable communication between itself and the other components of processing system 102.

Memory 204 includes both persistent and volatile memory (212 and 214) for the storage of: operational instructions for execution by CPU 202, data registers, application storage and the like. Memory 204 preferably includes a combination of random access memory (RAM), read only memory (ROM) and persistent memory such as that provided by a hard disk drive.

Network I/F 208 enables communication between computer system 100 and other network computing devices (not shown) via network 110. Network I/F 208 may be embodied in one or more conventional communication devices. Examples of a conventional communication device include an Ethernet card, a token ring card, a modem or the like. Network I/F 208 may also enable the retrieval or transmission of instructions for execution by CPU 202 from or to a remote storage media or device via network 110.

I/O I/F 210 enables communication between processing system 102 and the various I/O devices 104, 106. 1/0 I/F 210 may include, for example, a video card for interfacing with an external display such as output device 106. Additionally, 1/0 I/F 210 may enable communication between processing system 102 and a removable media 215. Although removable media 215 is illustrated as a conventional diskette other removable memory devices such as Zip™ drives, flash cards, CD-ROMs, static memory devices and the like may also be employed. Removable media 215 may be used to provide instructions for execution by CPU 202 or as a removable data storage device.

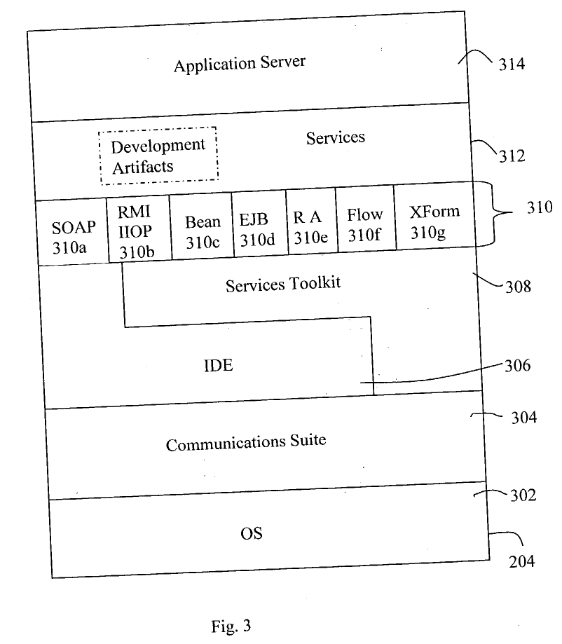

The computer instructions/applications stored in memory 204 and executed by CPU 202 (thus adapting the operation of computer system 100 as described herein) are illustrated in functional block form in FIG. 3. As will be appreciated by those of ordinary skill in the art, the delineation between aspects of the applications illustrated as functional blocks in FIG. 3 is somewhat arbitrary as the various operations attributed to a particular application as described herein may, in alternative embodiments, be subsumed by another application.

As illustrated, for exemplary purposes only, memory 204 stores operating system (OS) 302, communications suite 304, IDE 306 adapted with services toolkit 308, various service providers 310a-310g (collectively 310), services 312 comprising development artifacts (shown in doted outline) and application server 314 to which the services are deployed.

OS 302 is an operating system suitable for operation with a selected CPU 202 and the operations described herein. For example, IBM AIX®, Microsoft Windows NT™ or XP Professional™, Linux (Linux is a trademark of Linus Torvalds) or the like, are expected in many embodiments to be preferred.

Communication suite 304 provides, through, interaction with OS 302 and network I/F 208 (FIG. 2), suitable communication protocols to enable communication with other networked computing devices via network 110 (FIG. 1). Communication suite 304 may include one or more of such protocols such as TCP/IP, Ethernet, token ring and the like.

Also stored in memory 204 (and used during the development process) and incorporating aspects of the present invention is Integrated Development Environment (IDE) 306. In the exemplary embodiment, IDE 306 provides a developer (or a team of developers) a development environment using a graphical user interface (GUI) known to those of ordinary skill in the art. The GUI typically includes a number of windows or panes for viewing source code, project files, debugging information or the like.

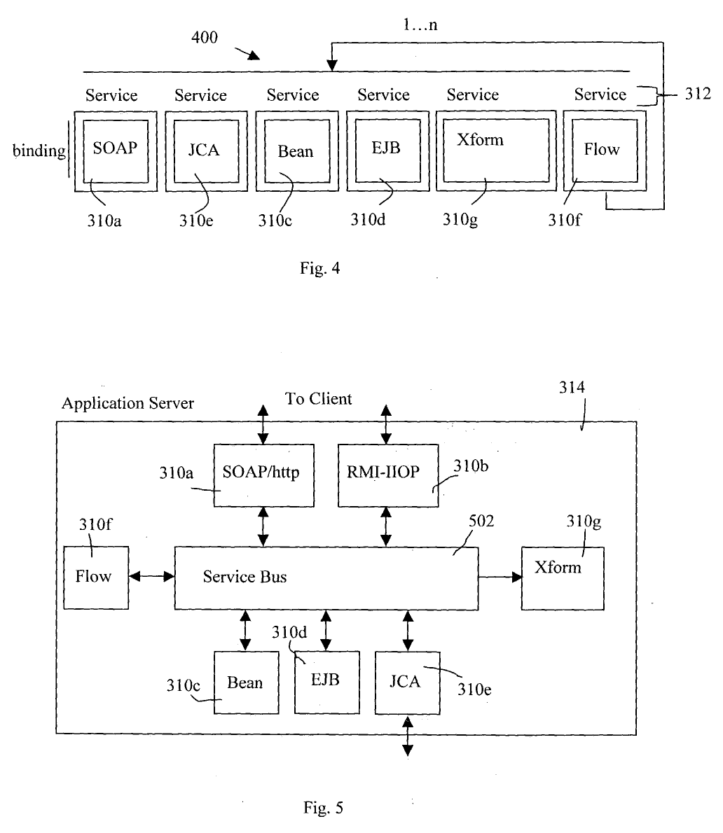

Unlike conventional IDEs, IDE 306 is adapted to have services toolkit 310 “plugged in”. Through tools of the services toolkit 308, IDE 306 is able to assist developers in developing a business or enterprise services application incorporating artifacts 312 designed to use the services provided by one or more selected service providers 310. FIG. 4 illustrates a definition for a service in accordance with the programming model 400 of the present invention and showing exemplary service providers. A service 312 is defined using a service provider such as a software asset, for example, a Java bean 31Oc or stateless session Enterprise Java Bean (EJB) 310d, resource adapted EIS services (RA 310e), such as J2EE Connector Architecture (JCA) connected or otherwise resource adapted service (for example, for facilitating EIS services such as CICS®, IMS™, IBM Host On Demand (HOD), and others), database assets (not shown) via a Java Database Connector (JDBC) and access protocols such as SOAP 310a or JMS (not shown).

J2EE Connector architecture (JCA) is described in greater detail in the document entitled “J2EE Connector Architecture Specification”, JSR 016, Version 1.0, Final Release, Released Aug. 22, 2001 from Sun Microsystems, Inc. of Palo Alto, Calif., the contents of which are hereby incorporated herein by reference. Integrating a JCA based resource adapter with the services toolkit is accomplished via a JCA tool plugin. The JCA tool plugin is a connector architecture extension to make connectors communicate with tool environments such as an IDE and is not specific to the present services toolkit. The tool plugin defines how to provide EIS-specific binding extensions and how the tool environment interacts with the EIS to get the information. Lastly, it defines how an EIS provides code generation contributions. The tool plugin also supplies JCA Common Client Interface (CCI) extensions for EIS system service invocations. While a tool plugin assists with working with the resource adapter, it can be directly worked using Java and EJB tools to wrap the connector functions in a Java Bean or stateless session EJB. Thereafter, the services toolkit can consume these services transparently as per other similar typed software assets.

Additionally a service may be defined using a flow service provider 310f which may use one or more services and including a service comprising a Transform (Xform) 310g service provider. As described in detail herein below, features like flow composition provided by flow 412 can be used to compose a new service out of other services. Transformations provided by Xform 414 allow the mapping of data from one or more messages received by a service to an output message for the service in a flow composition.

Access to services is made available via one or more access protocols such as Simple Object Access Protocol (SOAP) run over HTTP and Remote Method Invocation (RMI) run over Internet Inter-Orb Protocol (IIOP) (not shown). RMI-IIOP delivers Common Object Request Broker Architecture (CORBA™) distributed computing capabilities to the Java 2 platform. Other service provider options may be included, such as Java Messaging Service (JMS) (not shown) as will be apparent to those of ordinary skill in the art.

The operation of IDE 306 and services toolkit 308 and their interaction with service providers 310, services 312 and application server 314 is better understood with reference to FIGS. 5-10 described below.

Services Toolkit 308 provides service-oriented development environment for business and enterprise application integration for deployment to a server such as application server 314. With reference to FIG. 5, there is shown a logical schematic representation of memory 204 from the viewpoint of application server 314 having a logical service bus 502 that acts as the point of integration for the wide variety of services 312 offered by service providers 310a-310g. Services toolkit 308 provides tools and support needed to be able to consume and provide services to server 314 via the service bus 502.

At the core of the programming model 400 of the services toolkit 308 are enterprise services, or services 312 for short. Services 312 are used to model different kinds of service providers 310 in a consistent way. The following is an overview of the programming model 400:

Data: XML Schema, Service Message

Interface: Service Interface

Implementation: Service Binding

SOAP

Java bean

Stateless session EJB

JCA

Flow

Transformer

The part of the programming model 400 that ties the elements of the model together is the service 312. Services toolkit 308 employs a description mechanism namely, Web Services Description Language (WSDL), for describing any kind of service 312. WSDL is sufficiently extensible to describe any kind of IT services and not simply web services.

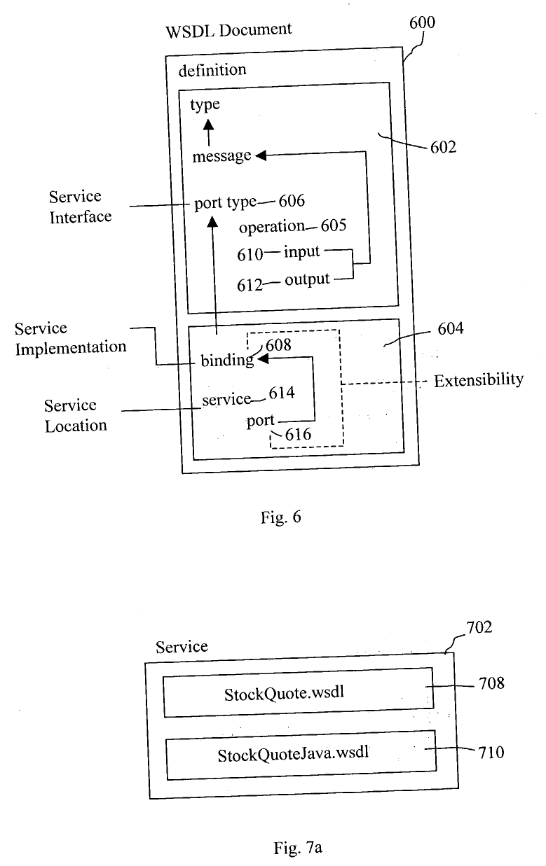

FIG. 6 illustrates WSDL document architecture 600 comprising an abstract service interface definition section 602 and service implementation and location definition section 604. The service interface in WSDL is called a portType 606. PortType 606 consists of one or more operations 608 with input 610 and output 612. Input 610 and output 612 are described by services messages typed using XML Schema to describe the business data that flows in and out of the services.

Service implementation and location definition section 604 describes how the service interface is implemented and where it can be found. The service location is described by a service provider specific port extensibility element 616. The service implementation is described by service provider specific extensibility elements in the binding section 618. Services toolkit 308 can be adapted to support a wide variety of service provider specific bindings such as SOAP, JCA, Java Bean, Stateless session EJB, Flow, and Transform, among others, as previously described.

WSDL provides a standard way for describing which services are offered by a service provider and how you access them. WSDL, in XML format, describes network services as a set of endpoints operating on messages containing either document-oriented or procedure-oriented information. The operations and messages are described abstractly and then bound to a concrete network protocol and message format to define an endpoint. Related concrete endpoints are combined into abstract endpoints (services). WSDL is extensible to allow description of endpoints and their messages regardless of what message formats or network protocols are used to communicate. WSDL can be better understood with reference to the World Wide Web Consortium (W3C) document entitled “Web Services Description Language (WSDL) 1.1” dated Mar. 15, 2001 the contents of which are hereby incorporated herein by reference. While the exemplary embodiment described herein utilizes WSDL, other languages which describe services could also be employed. For example, it is contemplated that the Electronic Business XML (ebXML) language promulgated, in part, by the United Nations Centre for Trade Facilitation and Electronic Business (UN/CEFACT) could, alternatively, be employed,

A document from the Sun Microsystems, Inc. (Java Community Process group) of Palo Alto, Calif. entitled JSR 110 “Java APIs for WSDL” describes a proposed standard set of APIs for representing and manipulating services described by WSDL documents. These APIs define a way to construct and manipulate models of service descriptions. The contents of “Java APIs for WSDL” is hereby incorporated herein by reference.

In accordance with the invention, flow 412 and Transform (sometimes referred to as Xform) 414 are each a specific form of service implementation. Flow 412 is useful to compose a service 312 out of other services 312 while Xform 414 provides a manner of mapping between service messages, including mapping multiple input messages to a single output message. A flow consists of service nodes, each node representing the invocation of a service operation. The service nodes are tied together by control links which indicate the sequence of execution and under which condition execution takes place. The data flow between service nodes is constructed using data links. These data links can include data mapping nodes (via Xform 414) for cases when messages between service nodes do not match and a new service message is to be produced. Flow composition may be described using a markup language. The transformation implementation is described in the form of XSLT.

XSLT (Extensible Stylesheet Language Transformation) is a language for transforming XML documents into other XML documents. XSLT addresses the need to have data presented differently to meet the particular requirements of an organization/individual by providing the ability to define a set of transformation rules to transform the data. XSLT can be better understood with reference to the World Wide Web Consortium (W3C) document entitled “XSL Transformations (XSLT) Version 1.0” dated Nov. 16, 1999.

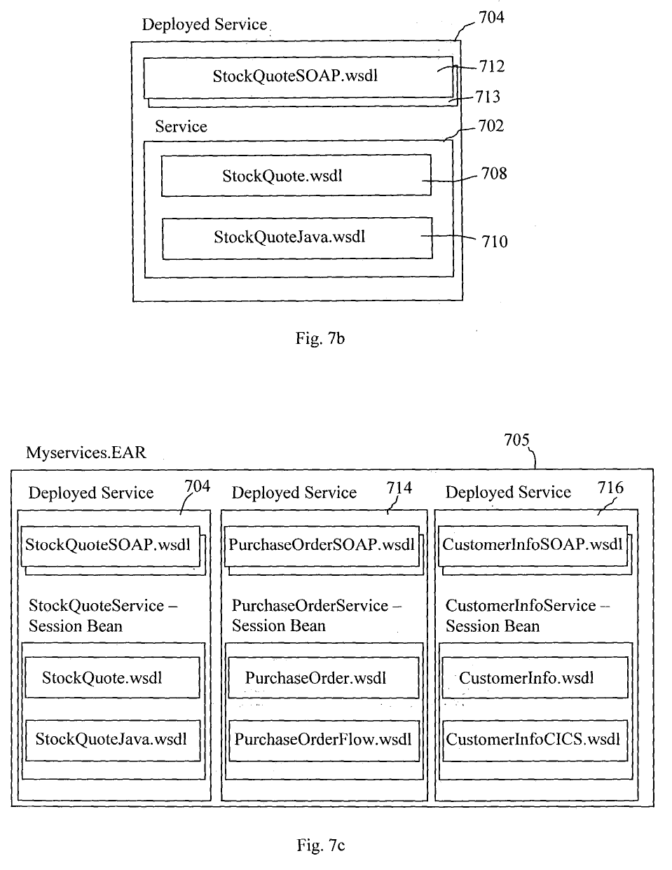

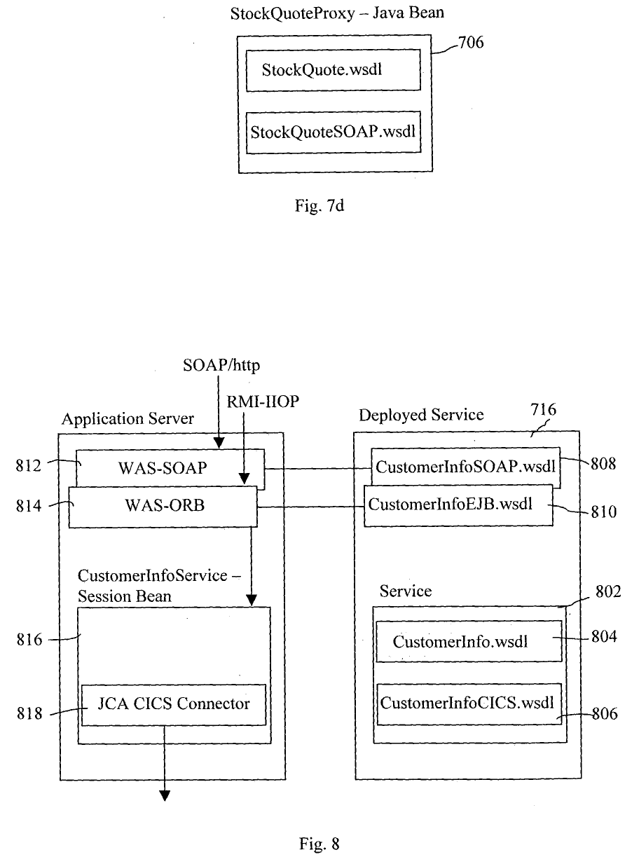

The development model of services toolkit 308 consists of three primary process steps: (1) creating a service; (2) deploying a service; and (3) creating a service proxy, each of which steps is described herein below in more detail, along with the development artifacts produced. FIGS. 7a, 7b, 7c and 7d illustrate in greater detail development artifacts 312 produced by services toolkit 306, namely an exemplary service 702, an exemplary deployed service 704, an exemplary deployed services archive 705 and an exemplary service proxy 706.

Service toolkit 308 can facilitate the creation of a service in different ways. First it facilitates creation of a service for an existing provider, for example, a Java Bean, a Stateless Session EJB, resource adapted services (e.g. JCA adapted CICS services) and others. Another form of service creation is through flow composition, where a service is created by composing it out of other services. Finally, a service may be created from scratch and from it a service provider may be created (that is, top-down development).

In accordance with an embodiment of services toolkit 308, when creating a service, the WSDL defining the service is partitioned into a services interface definition embodied in a document (“interface”.wsdl) comprising a WSDL abstract service interface definition section 602 (FIG. 6) and a services implementation and binding definition embodied in a document (“implementation_binding”.wsdl) comprising a WSDL service interface and binding section 604. It will be understood to persons skilled in that art that the message and type descriptions of section 602 could also be in separate files. WSDL artifacts are preferably partitioned into separate files to facilitate re-use, separating interfaces, which may be made public, from implementation details, which may be proprietary and desired to be kept private. Further, separation enhances transparency, permitting an implementation to change without impacting an interface.

The following Java and WSDL code samples shows how an exemplary service 702 (FIG. 7A) is created from an existing software asset type service provider (e.g. Java Bean 404), in this case from a StockQuote Java class:

```
package sample.stockquote;
public class StockQuote {
  public float getQuote(String symbol) {
    float quote = 0;
    // ...
    return quote;
  }
}
```

Creating the service from the StockQuote Java class results in the creation of two WSDL resources, one containing the StockQuote interface, namely StockQuote.wsdl 708, the other one containing the native Java binding of the StockQuote interface, namely StockQuote.Java.wsdl 710. The following WSDL sample shows the content of the StockQuote.wsdl 708 resource, including a StockQuote interface with the operation getQuote, and the service messages for the input and output of the operation.

```
StockQuote.wsdl: <?xml version=“1.0” encoding=“UTF-8”?>
<definitions name=“StockQuote”
  targetNamespace=“http://stockquote.sample/”
  xmlns=“http://schemas.xmlsoap.org/wsdl/”
  xmlns:tns=“http://stockquote.sample/”
    xmlns:xsd=“http://www.w3.org/2001/XMLSchema”>
  <message name=“getQuoteRequest”>
    <part name=“symbol” type=“xsd:string”/>
  </message>
  <message name=“getQuoteResponse”>
    <part name=“result” type=“xsd:float”/>
  </message>
  <portType name=“StockQuote”>
    <operation name=“getQuote” parameterOrder=“symbol”>
      <input message=“tns:getQuoteRequest” name=“
      getQuoteRequest”/>
      <output message=“tns:getQuoteResponse” name=“
      getQuoteResponse”/>
    </operation>
  </portType>
</definitions>
```

The following WSDL sample shows the content of the StockQuoteJava.wsdl 710 resource with the StockQuote Java class as the endpoint in the port section, and the native Java binding that references the interface defined in StockQuote.wsdl 708.

```
StockQuoteJava.wsdl:  <?xml version=“1.0” encoding=“UTF-8”?>
<definitions name=“StockQuoteJava”
  targetNamespace=“http://stockquote.sample/”
  xmlns=“http://schemas.xmlsoap.org/wsdl/”
  xmlns:format=“http://schemas.xmlsoap.org/wsdl/formatbinding/”
  xmlns:java=“http://schemas.xmlsoap.org/wsdl/java/”
  xmlns:tns=“http://stockquote.sample/”
  xmlns:xsd=“http://www.w3.org/2001/XMLSchema”>
    <import location=“StockQuote.wsdl” namespace=
    “http://stockquote.sample/”/>
  <binding name=“StockQuoteJavaBinding” type=“tns:StockQuote”>
  <java:binding/>
  <format:typeMapping encoding=“Java” style=“Java”>
    <format:typeMap formatType=“float” typeName=“xsd:float”/>
    <format:typeMap formatType=“java.lang.String” typeName=
    “xsd:string”/>
  </format:typeMapping>
  <operation name=“getQuote”>
      <java:operation methodName=“getQuote” parameterOrder=
      “symbol”
      returnPart=“result”/>
  <input name=“getQuoteRequest”/>
  <output name=“getQuoteResponse”/>
  </operation>
  </binding>
  <service name=“StockQuoteService”>
  <port binding=“tns:StockQuoteJavaBinding” name=
  “StockQuoteJavaPort”>
    <java:address className=“sample.stockquote.StockQuote”/>
  </port>
  </service>
</definitions>
```

When deploying a service to a server, additional definitions are provided for the inbound bindings by which the service is made accessible to a client application (not shown). An inbound binding is an outbound binding that a client of the service must use to invoke the service as described further below with respect to service proxies. In accordance with an embodiment of the services toolkit 308, an inbound binding may be a SOAP binding or a EJB binding which makes the service accessible by using the EJB programming model. Services toolkit 308 may also be adapted to support other inbound/outbound bindings such as JMS and others. FIG. 7b shows service 702 accessible through the SOAP protocol. That is FIG. 7b shows an exemplary deployed service 704 comprising service 702 and one or more additional inbound binding WSDL files, namely StockQuoteSOAP.wsdl 712. The inbound binding files contain the service location information as well as the inbound binding to the service interface.

The following WSDL sample code lists the content of the StockQuoteSOAP.wsdl 712 resource, with the SOAP address as the endpoint in the port section, and the SOAP binding referencing the interface defined in StockQuote.wsdl 708.

```
StockQuoteSOAP.wsdl: <?xml version=“1.0” encoding=“UTF-8”?>
<definitions name=“StockQuoteSOAPBinding”
  targetNamespace=“http://stockquote.sample/”
  xmlns=“http://schemas.xmlsoap.org/wsdl/”
  xmlns:soap=“http://schemas.xmlsoap.org/wsdl/soap/”
  xmlns:tns=“http://stockquote.sample/”>
  <import location=“StockQuote.wsdl”
  namespace=“http://stockquote.sample/”/>
  <binding name=“StockQuoteSOAPBinding” type=“tns:StockQuote”>
  <soap:binding style=“rpc” transport=
  “http://schemas.xmlsoap.org/soap/http”/>
  <operation name=“getQuote”>
  <soap:operation soapAction=“urn:StockQuote” style=“rpc”/>
  <input name=“getQuoteRequest”>
    <soap:body
      encodingStyle=“http://schemas.xmlsoap.org/soap/encoding/”
      namespace=“urn:StockQuote” parts=“symbol” use=“encoded”/>
  </input>
  <output name=“getQuoteResponse”>
    <soap:body
      encodingStyle=“http://schemas.xmlsoap.org/soap/encoding/”
      namespace=“urn:StockQuote” parts=“result” use=“encoded”/>
  </output>
  </operation>
  </binding>
  <service name=“StockQuoteService”>
  <port binding=“tns:StockQuoteSOAPBinding”
      name=“StockQuoteSOAPPort”>
    <soap:address
      location=“http://localhost:8080/
      Services_SOAP/servlet/rpcrouter”/>
  </port>
  </service>
</definitions>
```

Services toolkit 308 also generates a thin stateless session EJB wrapper (i.e. bindings) StockQuoteEJB.wsdl 713 for the service 702. StockQuoteEJB.wsdl describes the thin stateless 30 session EJB wrapper. Standard EJB deployment descriptor definitions can be used to specify additional Quality of Service (QOS) attributes for the deployed service, for example, security and transactional attributes as will be apparent to those of ordinary skill in the art.

Deployed services are installed into application server 314 by packaging them into a J2EE enterprise archive (EAR) file such as exemplary archive 705 as shown FIG. 7c. Exemplary archive 705 illustrates exemplary deployed service 704 for a stock quote service together with additional deployed services 714 and 716 for a purchase order service and a customer information service, respectively, in EAR “Myservices.ear” 705. StockQuote service 704 is accessible through SOAP and provided by a Java class. PurchaseOrder service 714 is accessible through SOAP and provided by a flow and CustomerInfo service 716 accessible through SOAP and provided by a resource adapted CICS service.

FIG. 8 illustrates how a deployed service, such as CustomerInfo 716, manifests itself in server 314. In this sample, deployed service 716 is provided by a CICS service requiring a resource adapter such as a JCA service provider. Deployed service 716 is accessible from the client side by the SOAP protocol (for example as a web service) and the EJB programming model (for example for a more local, private invocation). As described above, deployed service 716 comprises service 802 having interface and implementation artifacts 804 and 806, respectively, and inbound bindings development artifacts 808 and 810. The artifacts 808 and 810 are files “customerlnfoSOAP.wsdl” and “CustomerInfoEJB.wsdl” providing binding descriptions to the application server components 812 and 814 for SOAP and RMI-IIOP object request broker (ORB) access. The artifacts 804 and 806 are the files “Customerlnfo.wsdl” and “CustomerlnfoCICS.wsdl” providing descriptions of the target CICS service to session bean component 816 including a JCA CICS connector run-time component 818. Server component 812 receives and responds to service invocation requests (e.g. remote procedure calls (RPC)) via SOAP over HTTP protocols. Using artifact 808, the SOAP server component determines the particulars for service invocation. In the present example, SOAP provides a front end to the session EJB 816. Session EJB 816 recognizes the request and invokes the CICS service. Session EJB 816 acts as a proxy to the CICS service to provide the result. Similarly, ORB run-time component 814 may receive a RMI-IIOP invocation for session EJB 816 and pass the invocation through. When the customerlnfo service is deployed, an EJB deployment descriptor for session EJB 816 is generated from the corresponding WSDL information 810 and ORB component 814 is configured with this deployment descriptor. The deployment descriptor provides a way to route an incoming RMI-IIOP request to the appropriate session bean.).

Creating a service proxy, such as exemplary proxy 706 illustrated in FIG. 7d, involves creating a Java Bean which may be invoked by a client application (not shown) to access a deployed service, for example, exemplary deployed service 704. A service proxy is generated from a service interface for the service to be invoked and an outbound binding that describes how to access the service interface. The outbound binding used by the proxy is the inbound binding with which the service is deployed. As such, exemplary service proxy 706 for exemplary deployed service 704 comprises interface StockQuote.wsdl 708 and binding StockQuoteSOAP.wsdl 712.

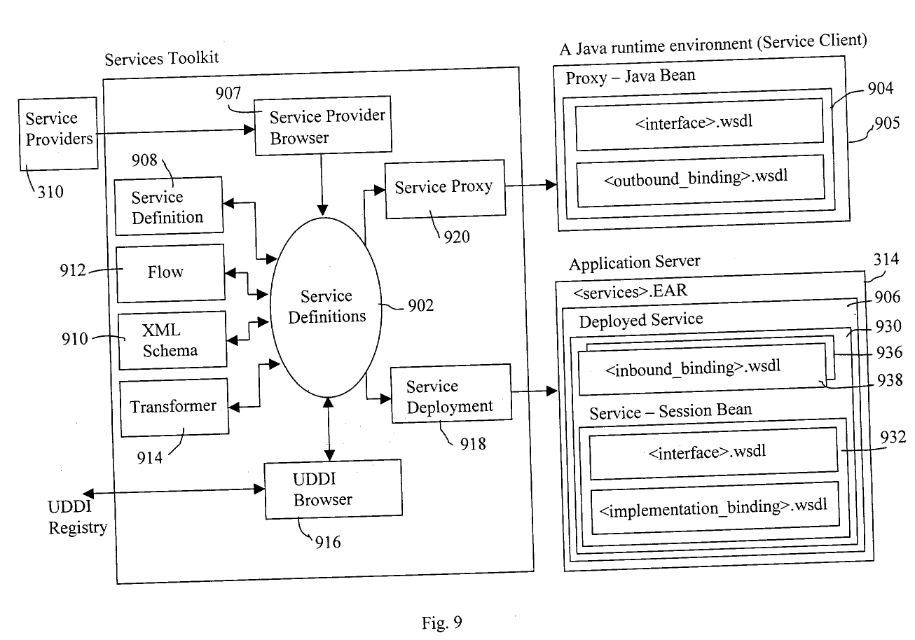

Services toolkit 308 provides a set of tool components, such as wizards and editors etc., to simplify business and enterprise application integration tasks. The tool components are grouped and presented conveniently in a service perspective or view, which extends base tool components available in a typical IDE. For simplicity, the set of tool components is referred to as the services toolkit. FIG. 9 shows the tool component architecture of services toolkit 308 along with the development artifacts produced by the tool components.

A main function of the services toolkit 308 is the facilitation of service definitions 902. Various tools aid a user to create and edit the different aspects of service definitions 902 and to use the definitions 902 to create additional development artifacts 904 and 906 for an application server, such as server 314, and for a service client (not shown).

Services toolkit 308 provides a graphic user interface (GUI) for working with service definitions having customizable perspectives for presenting views to promote role-based development. A service perspective customizes the layout of the GUI to facilitate the development of enterprise services containing the views of various resources for use to develop such services. As is commonly understood to persons skilled in the art, there are several ways to launch tool components from a perspective in a GUI-based IDE including a toolbar, pop-up menu choices and a resource creation dialog or wizard.

A service view contained in the perspective provides a view of service resources such as three folders comprising, respectively, service projects containing service definitions; deployed services containing the services that have been deployed; and resource adapters containing one or more JCA or CCF or other resource adapters added (i.e. plugged in) to the IDE for facilitating services from EISs. A service project wizard (not shown) is provided for creating and manipulating service projects.

A service provider browser 907 provides a central tool to create services from existing service providers collectively 310 such as Java Beans, Stateless Session EJBs, 3270 Terminals, and EIS systems made accessible by the JCA Tool Plugin as described previously. The browser 907 presents the services and options offered by a particular service provider type to the user. A service definition wizard and editor 908 assists with creating new service definitions (that is, WSDL documents in the present embodiment). Service definition editor 908 is provided for editing these definitions, providing source editing as well as a browser style design editing capability.

As noted previously, XML schema definitions are used in service definitions to type service messages, modeling business data. A XML schema wizard and editor 910 allows a user to create XML schema definitions. A flow wizard and editor 912 facilitates the creation of a service implementation by flow, composing the service out of other services. Flow editor 912 is a graphical composition tool that allows scripting of services visually. To use services in a flow composition, services represented by icons are simply dragged and dropped from the service view into the flow editor 912. The flow of control between the services gets expressed by control links, the flow of data by data links which can contain data mappings when necessary.

In conjunction with the flow editor 912, a transformer wizard 914 creates message transformations to define mappings between service messages. The resulting transformer is itself a service and its operation is implemented using the XSLT specification as discussed previously.

UDDI Browser 916 facilitates importing service definitions from a Universal Description, Discovery, and Integration (UDDI) registry for web services. UDDI provides a “meta service” for locating web services useful in private as well as public deployments. Once imported, the service definition may be used like any other service definition created with the services toolkit 308, for example, in a flow. A UDDI Export function exports service definitions for deployed web services to a UDDI registry so that other registry users can find and use the service.

Though not illustrated, a service skeleton wizard creates service provider skeletons from service definitions. The skeleton tool examines the service definition and generates an implementation skeleton from the definition. This tool can be used for a top-down approach to creating a service provider; that is, starting with the service definition and then creating the implementation.

A deployment wizard 918 creates deployed services from service definitions, such as exemplary deployed service 930 comprising exemplary service 932, into an Enterprise Archive (EAR) file (for example file 906) that can be installed into an application server 314. For each deployed service a thin stateless session bean wrapper 936 gets generated, and inbound bindings 938 can be configured through which the service should be accessible.

A service proxy wizard 920 creates proxies (such as a Java Bean proxy 904) for services to simplify interactions between deployed services 930 and client applications operating in a run-time environment 905.

Services toolkit 308 may be adapted or associated with server tools (not shown) for use with a test environment, which can be used to-efficiently test deployed services. Server tools may be employed to set up a test server (not shown) and an association may be made between the EAR file that contains deployed services for testing with the test server. A first level of testing can be done using a generic EJB test client to exercise the session EJB that was created for the service. A next level of test would be to create a Java proxy to exercise the deployed service, for example, to access the service using the SOAP protocol. In each case, a Java debug environment is used to debug Java code and the code generated by the services toolkit.

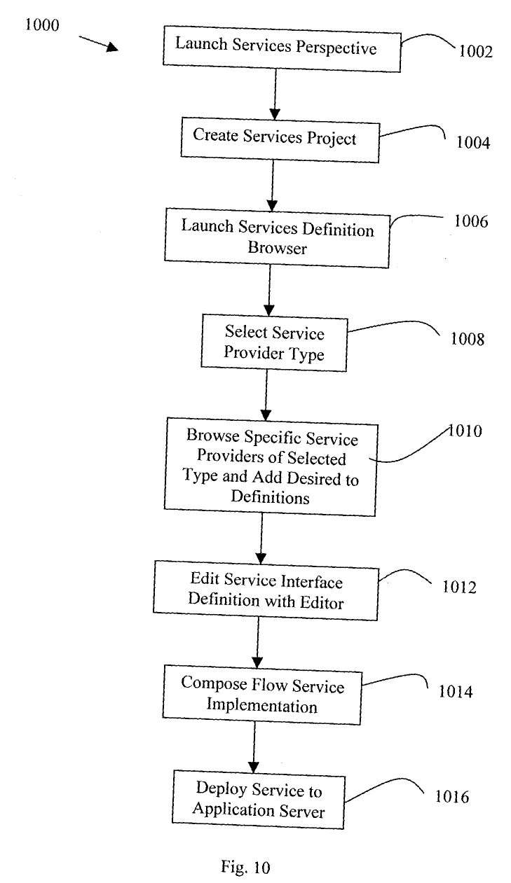

Use of IDE 306 and services toolkit 308 is described herein below by way of example and with reference to operations 1000 of FIG. 10. The example relates to the use of Java bean based services to compose a new service through flow composition. The composed service is then deployed into an application server and made accessible through the SOAP protocol. A Java proxy is created to make the SOAP service accessible from a Java application.

Upon start-up of operations 1000, IDE 306 adapted with services toolkit 308 launches a services perspective offering access, such as via a toolbar or pop-up menu choices, to tool components needed to accomplish service development tasks (Step 1002). To create a service project to contain the service definitions created in accordance with the following exemplary steps, a service project wizard may be employed and the requested particulars provided (Step 1004). After the service project is created, service provider browser 906 is employed to create service definitions from existing service providers 907 (Step 1006). Service provider browser 906 informs the user about which service providers 907 are available, for example, Java classes, stateless session EJBs, 3270 Terminal services, resource adapters or connectors for EIS or other legacy services such as CICS, and others.

Service provider browser 906 may be launched from within a service project and the service provider type to be used is selected. In the present example, the services are based on Java classes, and the Java class services option is selected (Step 1008). Thereafter, service provider browser 906 facilitates the browsing of available Java classes to select one or more desired classes to add the class' service definition to the service project (Step 1010). The Java classes themselves may have been previously created in the service project using the Java IDE tools that are part of IDE 306 or those classes could be contained in any other Java project.

Following selection of particular Java classes, a service definition is created using the service definition editor (Step 1012). Simply and advantageously, only a service interface (portType) and its associated messages as described previously need be created in an interface WSDL document artifact. Service definition editor 908 may offer design and source editing such as by way of different views as will be understood by persons of ordinary skill in the art.

Thereafter, the service implementation WSDL document for the service interface is constructed using on of the service implementation editors, in this example, flow editor 912 for flow composition (Step 1014). Flow editor 912 is used to visually compose a new service out of other existing services. Service definitions created previously from Java classes in the services perspective may be dragged and dropped into the flow editor. Control links between services are added, for example, visually represented by connecting a line between the services and defined to control the sequence in which a flow executes. The passing of data is controlled through data links comprising data maps for cases where message types do not match between services. Such may be defined with transformer wizard 914. Flow editor 912 constructs a service implementation WSDL artifact.

Once the flow-based service (e.g. 932) is determined, the service is deployed to an application server 314. In accordance with the present example, the services are packaged as a Stateless Session EJB and given further access by SOAP protocol bindings. In order to deploy the service as described (Step 1016), the service is packaged into an Enterprise Archive (EAR) file (e.g. 934) and the archive comprising the service is then installed into the application server 314 using the deployment wizard 918. The inbound bindings are selected to specify how access to the service will be provided. In this example, the SOAP protocol is selected. In the deployed services section of the services perspective view, the results (i.e. artifacts) of the deployment step are displayed. The artifacts comprise the Stateless Session EJB wrapper, the EJB binding WSDL file 936, and the SOAP binding WSDL file 938.

Once the application server is started with this EAR, the flow-based service can either be accessed using the EJB programming model or through SOAP. The SOAP binding WSDL file 938 can be published for public use (for example, via UDDI Export 916 with the service interface WSDL) to make the service accessible via a registry (publicly or not) and the EJB bindings 936 and the EJB wrapper details may be restricted.

The SOAP binding WSDL file 938 that provides inbound descriptors for the application server side also provides outbound binding descriptors for a client application. Service proxy wizard 920 can be employed to create a Java proxy via SOAP 905 protocol to the deployed service 930.

The services-oriented architecture described herein is intended to allow developers to tie Java and non-Java applications together with existing Web services to create logical flow-based enterprise services. Users can make such services available on an application server and even expose the services as a Web service. An IDE as adapted by the services toolkit described above and application server help build new applications that integrate with existing assets by leveraging a service-oriented architecture to reduce the complexity of large-scale application development and promote reuse by offering a standard way of representing and interacting with virtually all software assets. Integrated workflow increases productivity by enabling developers to visually choreograph interactions between software assets. Advanced transactional connectivity capabilities help developers avoid custom coding by providing extended transactional support for the many challenges related to integrating existing software assets with a J2EE environment.

As will be appreciated by those skilled in the art, modifications to the above-described embodiment can be made without departing from the essence of the invention. For example, in addition to or in lieu of SOAP inbound bindings, JMS or other middleware service bindings can be used for deployed services. While services toolkit 308 is provided to create the WSDL files and other artifacts, it will be appreciated by those of ordinary skill in the art that such artifacts may be created without toolkit assistance.

While one (or more) embodiment(s) of this invention has been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto. Other modifications will be apparent to those skilled in the art and, therefore, the invention is defined in the claims.

We claim:

1. A method for architecting an enterprise application comprising:
creating one or more services that define said enterprise application, each service created in accordance with a service definition modeling one of a plurality service providers having one of a plurality of service provider types, the service definition conforming to a standard common for differing service provider types; and
deploying the one or more services, each deployed in accordance with an access definition sufficient to access the service;
wherein said differing service provider types comprise at least two types selected from: access protocols; software assets; resource adapted EIS services; a flow composition defining a service from one or more other services; and a transformer mapping one or more input messages of a particular service to an output message of the particular service.

2. The method of claim 1 wherein the service definition comprises a service interface definition and a service implementation definition and wherein the step of creating comprises, for each service:
generating a service interface definition modeling the interface of the service provider; and
generating a service implementation definition describing an implementation of the service interface and the location of the implementation.

3. The method of claim 2 wherein the service interface definition and service implementation definition comprise separate documents.

4. The method of claim 3 wherein the documents conform to the WSDL standard.

5. The method of claim 2 including the step of publishing the service interface definition and access definition to facilitate creating a client application to use the deployed service.

6. The method of claim 1 wherein the step of deploying comprises adapting the deployed service for operation on an application server.

7. The method of claim 1 further comprising a step of:
defining a service proxy for accessing the deployed service.

8. The method of claim 7 wherein the service proxy is defined from a portion of the service definition describing an interface to the service and the access definition for accessing the deployed service.

9. A services toolkit for architecting an enterprise service comprising:
a service creation component for creating one or more services that define said enterprise application, each service created in accordance with a service definition modeling one of a plurality service providers having one of a plurality of service provider types, the service definition conforming to a standard common for differing service provider types, the differing service provider types comprising at least two types selected from: access protocols; software assets; resource adapted EIS services; flow compositions, each flow defining a service from one or more other services; and transformers each transformer mapping one or more input messages of a particular service to an output message of the particular service; and
a service deployment component for deploying the one or more services, each deployed in accordance with an access definition sufficient to access the service;
wherein the services toolkit is adapted to communicate with an integrated development environment to assist with architecting the enterprise application.

10. The services toolkit of claim 9 wherein the service creation component comprising one or more tools to assist with the creation of the service definition for each service provider type.

11. The services toolkit of claim 10 comprising a service provider browser to facilitate a selection of a service provider type to create the service definition.

12. The services toolkit of claim 9 wherein the service definition comprises a service interface definition and wherein the service creation component comprises:
a service definition editor for generating a service interface definition modeling the interface of the service provider.

13. The services toolkit of claim 9 wherein the service definition comprises a service implementation definition and wherein the service creation component comprises:
at least one service implementation editor for generating a service implementation definition describing an implementation of a service interface of the service and a location of the implementation.

14. The services toolkit of claim 13 wherein one of the at least one service implementation editors comprises a flow editor for generating flow compositions graphically.

15. The services toolkit of claim 13 wherein one of the at least one service implementation editors comprises a transformer editor for defining data transformations in accordance with a standard therefor.

16. The services toolkit of claim 9 wherein the service definition comprises a service interface definition and a service implementation definition defined by separate documents.

17. The services toolkit of claim 16 wherein the documents are XML documents.

18. The services toolkit of claim 17 wherein the XML documents conform to the WSDL standard.

19. The services toolkit of claim 9 including a tool for at least one of importing and exporting the service definition to facilitate creating at least one of a service and a client application to use the service.

20. The services toolkit of claim 9 wherein the service deployment component comprises a tool for adapting the deployed service for operation on an application server.

21. The services toolkit of claim 9 comprising:
a service proxy wizard for creating a service proxy to access the deployed service.

22. The services toolkit of claim 21 wherein the service proxy wizard is operable with the access definition and the service definition to generate the service proxy.

23. The services toolkit of claim 9 comprising a service skeleton wizard to at least partially generate a service provider from a service definition.

24. The services toolkit of claim 9 wherein the enterprise application is operable in a J2EE environment.

25. The services toolkit of claim 24 wherein the access protocols are selected from protocols operable to invoke Java based components; wherein the software assets are selected from Java based software components; and wherein the resource adapters are selected from resource adaptors operable in accordance with Java based connector standards.

26. A computer program product embodied in a computer readable medium for providing instructions and data to a computer system executing an integrated development environment (IDE) for architecting an enterprise service application, said instructions and data defining a services toolkit that, when operated on said computer system, adapts said IDE to:
create one or more services that define said enterprise application, each service created in accordance with a service definition modeling one of a plurality service providers having one of a plurality of service provider types, the service definition conforming to a standard common for differing service provider types; and
deploy the one or more services, each deployed in accordance with an access definition sufficient to access the service;
wherein the differing service provider types comprise at least two types selected from: access protocols; software assets; resource adapted EIS services; flow compositions, each flow defining a service from one or more other services; and transformers each transformer mapping one or more input messages of a particular service to an output message of the particular service.

27. An integrated development environment (IDE) for architecting an enterprise service comprising:
first means for describing a service interface to a service;
second means for describing a service implementation to the service, said service implementation binding the service interface to one of a plurality service providers having one of a plurality of service provider types, the second means conforming to a standard common for differing service provider types, the differing service provider types comprising at least two types selected from: access protocols; software assets; resource adapted EIS services; flow compositions, each flow defining a service from one or more other services; and transformers each transformer mapping one or more input messages of a particular service to an output message of the particular service;
third means for generating a service from said first and second means;
fourth means for describing a protocol sufficient to access the service; and
fifth means for deploying the service in accordance with the fourth means.

28. The IDE of claim 27 wherein the first, second and fourth means comprise XML-based documents.
